(19) United States
(12) Patent Application Publication
(10) Pub. No.: US 2021/0285473 A1
(43) Pub. Date: Sep. 16, 2021

(54) FLOW STRAIGHTENING BLANK

(71) Applicant: HALLIBURTON ENERGY SERVICES, INC., Houston, TX (US)

(72) Inventor: Robert Cecil MOGER, Duncan, OK (US)

(73) Assignee: Halliburton Energy Services, Inc., Houston, TX (US)

(21) Appl. No.: 16/484,041

(22) PCT Filed: May 17, 2017
(86) PCT No.: PCT/US2017/033103

§ 371 Date: Aug. 6, 2019

(51) Int. Cl. F15D 1/04; F16L 55/00

(52) U.S. Cl. CPC F15D 1/04; E21B 17/006; F16L 55/00

(57) ABSTRACT

Disclosed embodiments include a flow straightening device. The flow straightening device includes a blank end. The blank end designed to reside within a portion of piping to contain fluid flow within the piping. The flow straightening device also includes a straightening vane extending perpendicularly from the blank end along a longitudinal axis of the blank end. The straightening vane is designed to straighten the fluid flow as the fluid flow traverses a turn within the piping.

### BACKGROUND

The present disclosure relates generally to blanks used to seal open ends of frac iron in a hydraulic fracturing system, and more specifically to flow straightening capabilities of the blanks used to seal the open ends of the frac iron.

During stimulation of a well (e.g., during hydraulic fracturing or acidizing), flow of stimulation fluid may be disrupted as the stimulation fluid travels from a pumping system to the well through a piping system (e.g., through frac iron). For example, when the stimulation fluid flows through a turn within the piping system, the stimulation fluid may begin to rotate in a spiral motion around an inner diameter of the piping system as the stimulation fluid continues to flow toward an outlet of the piping system. The spiral rotation of the stimulation fluid increases the velocity of the stimulation fluid within the piping system. Increasing the velocity of the stimulation fluid results in excessive erosion of components within the piping system and excessive vibration of the piping system itself.

### BRIEF DESCRIPTION OF THE DRAWINGS

Illustrative embodiments of the present disclosure are described in detail below with reference to the attached drawing figures, which are incorporated by reference herein, and wherein:

FIG. 1 is a perspective view of a blank and straightening vane;

FIG. 2 is a diagram illustrating fluid flow within fluid tubing of a well stimulation system;

FIG. 3 is a sectional view of the fluid tubing of FIG. 2 using the blank and straightening vane of FIG. 1;

FIG. 4 is a diagram illustrating fluid flow within the fluid tubing of FIG. 2 using the blank and straightening vane of FIG. 1;

FIG. 5 is a perspective view of a blank and straightening vane with a cylindrical vane;

FIG. 6 is a sectional view of the blank and straightening vane of FIG. 5 positioned within a section of fluid tubing;

FIG. 7 is a perspective view of a blank and straightening vane with an airfoil shaped vane;

FIG. 8 is a sectional view of the blank and straightening vane of FIG. 7 positioned within a section of fluid tubing;

FIG. 9 is a perspective view of a blank and straightening vane with a cuboid shaped vane; and

FIG. 10 is a sectional view of the blank and straightening vane of FIG. 9 positioned within a section of fluid tubing.

The illustrated figures are only exemplary and are not intended to assert or imply any limitation with regard to the environment, architecture, design, or process in which different embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the disclosed subject matter, and it is understood that other embodiments may be utilized and that logical structural, mechanical, electrical, and chemical changes may be made without departing from the spirit or scope of the disclosure. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

As used herein, the singular forms “a,” “an,” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the embodiments and figures provided below are merely illustrative and do not imply that any particular step or component is a requirement of a claimed embodiment.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to”. Unless otherwise indicated, as used throughout this document, “or” does not require mutual exclusivity.

The present disclosure relates to limiting turbulence and a spiral velocity in a flow of fluid within fluid tubing, such as frac iron, as the fluid flows through a turn in the fluid tubing. More particularly, the present disclosure relates to a blank and straightening vane positioned at a turn in the fluid tubing to straighten the flow of fluid as the fluid travels through the turn. The presently disclosed embodiments may be used with stimulation fluids pumped into a wellbore (e.g., hydraulic fracturing fluid or acidizing fluid) or any other fluids where a straightened flow through fluid tubing is desirable. Further, the presently disclosed embodiments may be used in either onshore or offshore stimulation operations. Embodiments may be implemented to reduce turbulence and flow velocity of the fluid within the fluid tubing.

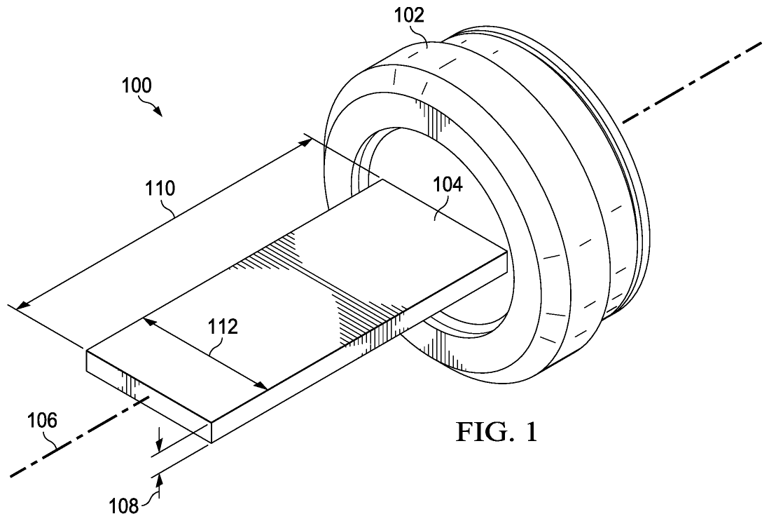

Referring to FIG. 1, a perspective view of a blank and straightening vane 100 is provided. The blank and straightening vane 100 includes a blank end 102 and a straightening vane 104. The blank end 102 may be welded, machined, or coupled mechanically onto an unused port of a tee, wye, or cross fitting pipe configuration to prevent flow of fluid in a direction of the unused port of the tee, wye, or cross fitting pipe configuration. In another embodiment, the blank end 102 may include threads that mate with matching threads within the pipe configuration to install the blank end 102 within the unused port of the pipe configuration.

The straightening vane 104 protrudes from the blank end 102 along a longitudinal axis 106 of the blank and straightening vane 100. In the illustrated embodiment, the straightening vane 104 includes a thickness 108 of approximately ½ inch. In other embodiments, the thickness 108 may be in a range of approximately ⅛ inch to 1.5 inches thick. As used herein, the term “approximately” indicates that a value falls within ten percent of the described amount. For example, an approximately 1 inch thick straightening vane 104 indicates that the thickness 108 of the straightening vane 104 is in the range of 0.9 inches to 1.1 inch.

The straightening vane 104 extends from the blank end 102 along the longitudinal axis 106 a length 110 of approximately 6 inches. In other embodiments, the length 110 may be in the range of approximately 1 inch to approximately 24 inches. Further, a width 112 of the straightening vane 104 is approximately 3 inches. In the illustrated embodiment, the width 112 and the thickness 108 (e.g., widths of rectangular faces of a rectangular prism that makes up the straightening vane 104) are at least 0.5 inches thick. In other embodiments, the width 112 may be in the range of approximately 0.25 inches to an entire width of the blank end 102. By way of example, the blank end 102, which is sized to fit within the fluid tubing, may be approximately three inches across to fit within a standard section of three inch diameter frac iron. In such an embodiment, the width 112 of the straightening vane 104 may be approximately three inches. The blank and straightening vane 100 may be made from steel, alloy steels, corrosion resistant alloys, or any other material composition, suitable to withstand erosive qualities of the fluid flow across the straightening vane 104.

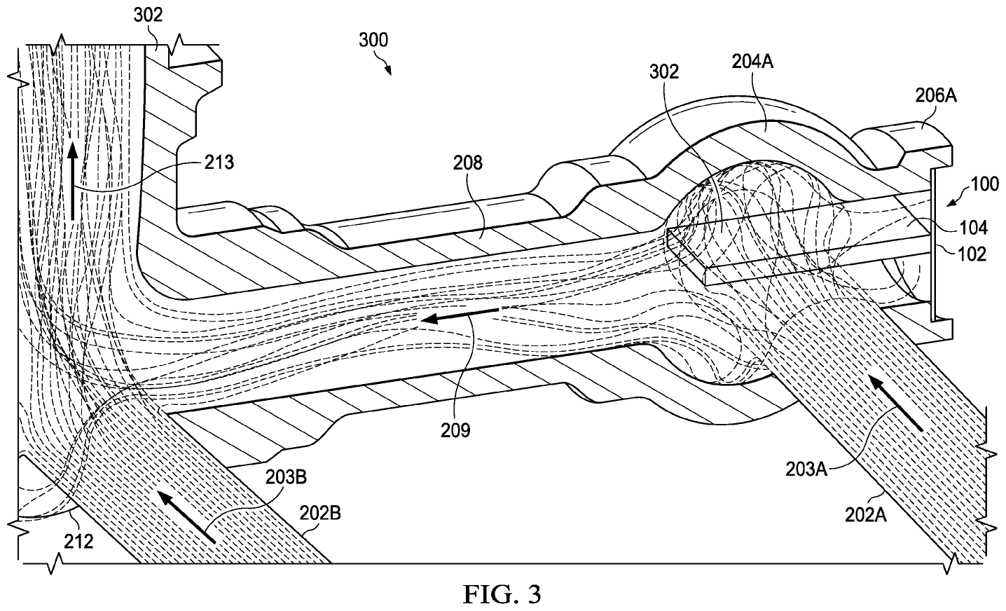

As discussed in detail below with respect to FIG. 3, the blank and straightening vane 100 reduces turbulence within fluid tubing as the fluid flows through a turn of the fluid tubing. Further, the straightening vane 104 straightens the flow of the fluid when the fluid begins flowing in the direction of the longitudinal axis 106. That is, the straightening vane 104 prevents spiraling of the flow of fluid after the fluid traverses a turn within the fluid tubing.

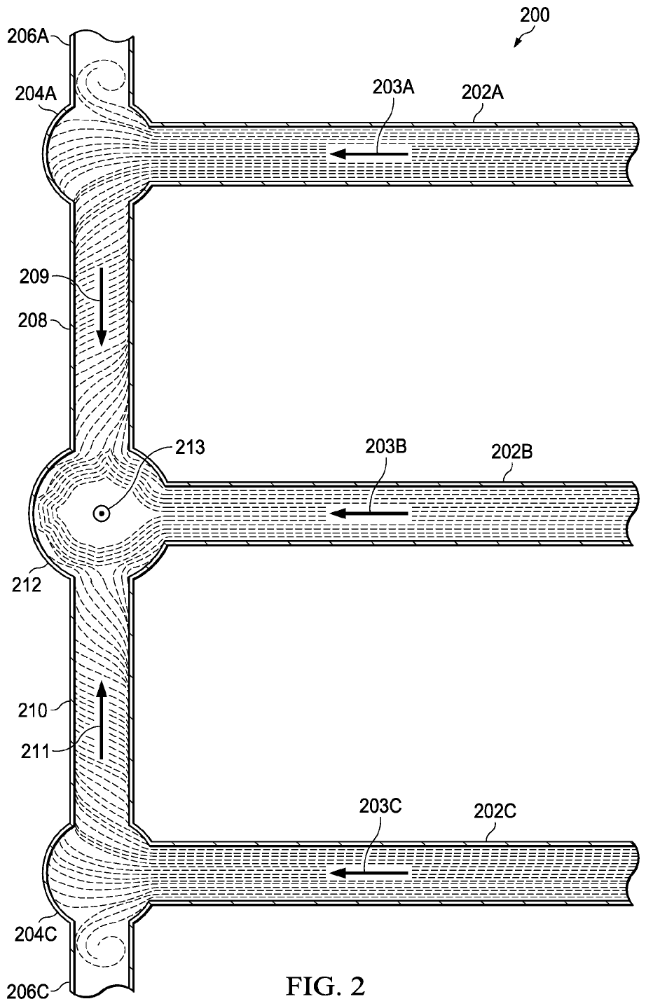

FIG. 2 is a diagram illustrating fluid flow within fluid tubing 200 of a well stimulation system. The fluid tubing 200 may, for example, be a system of frac iron that directs hydraulic fracturing fluid from pumps into an oil and gas well. The fluid tubing 200 may also represent tubing associated with other forms of fluid transport from one location to another. As illustrated, the fluid tubing 200 includes inlet lines 202A, 202B, and 202C. The inlet lines 202A, 202B, and 202C receive fluid from pumps (not shown) and direct the fluid in directions 203A, 203B, and 203C toward the well.

As the fluid travels in the directions 203A and 203C, the fluid eventually travels into spherical cavities 204A and 204C. The spherical cavities 204A and 204C represent tee fittings in the fluid tubing 200. Ports 206A and 206C of the spherical cavities 204A and 204C, respectively, are capped to direct fluid toward pipe sections 208 and 210, respectively. As the fluid turns toward the pipe sections 208 and 210 from the spherical cavities 204A and 204C, the fluid may gain significant amounts of turbulence, and the fluid may begin a spherical rotation as the fluid travels in directions 209 and 211 toward a center spherical cavity 212. The spherical rotation of the fluid in the pipe sections 208 and 210 may increase velocity of the fluid from approximately 35 feet per second (fps) at the inlet lines 202A and 202C to 70 or more fps within the pipe sections 208 and 210. Because the fluid, such as fracturing fluid, may contain a proppant or other abrasive component, the increase in velocity and turbulence of the fluid as the fluid enters the pipe sections 208 and 210 may result in erosion of the fluid tubing 200 and unwanted vibration in the fluid tubing 200.

After traveling through the pipe sections 208 and 210, the fluid joins with fluid from the inlet line 202B at the center spherical cavity 212. Upon reaching the center spherical cavity 212, the combined fluid is directed in a direction 213 toward the oil and gas well. Because the combined fluid travels to the well, reducing fluid turbulence and spiral velocity also reduces potential for eroded pieces of the fluid tubing 200 to be carried by the fluid into the well.

FIG. 3 is a sectional view 300 of the fluid tubing 200 using the blank and straightening vane 100 in the port 206A of the spherical cavity 204A. As illustrated, the blank end 102 is welded or machined onto the port 206A. The straightening vane 104 extends from the blank end 102 in the direction 209 toward the center spherical cavity 212. Additionally, the straightening vane 104 is positioned in an orientation such that a rectangular face 304, which has a surface area greater than or equal to a remainder of the rectangular faces of the straightening vane 104, is on a plane that is parallel with the direction 203A.

Because of the orientation of the straightening vane 104, the flow of fluid in the direction 209 does not include as much spherical velocity in the pipe section 208 as provided in the pipe section 208 illustrated in FIG. 2. Additionally, turbulence generated within the spherical cavity 204A is reduced in relation to the embodiment depicted in FIG. 2. Due to a reduction in spherical velocity of the flow of fluid within the fluid tubing 200 and a reduction in flow turbulence, the erosion of the fluid tubing 200 is also limited. Decreasing erosion of the fluid tubing 200 increases a lifespan of the fluid tubing 200 and limits impurities resulting from erosion of the fluid tubing 200 from entering the oil and gas well during a stimulation operation.

Although FIG. 3 illustrates the blank and straightening vane 100 installed within the port 206A of the spherical cavity 204A, the blank and straightening vane 100 may be installed in other tee or wye shaped fittings of the fluid tubing 200. For example, the spherical cavity 204A may be replaced by a more cylindrical tee shaped fitting (e.g., without the illustrated spherical shape). Alternatively, the spherical cavity 204A may also by in a wye shaped fitting orientation. That is, instead of a 90 degree turn, as depicted in FIG. 3, a turn greater than approximately 30 degrees and less than 90 degrees is also contemplated within the spirit of the disclosure. Further, the spherical cavity 204A may be replaced by a pipe joint with any number of ports with at least one inactive port in which the blank and straightening vane 100 is installed. For example, the pipe joint using the blank and straightening vane 100 may include four ports, five ports, or six ports with a blank and straightening vane 100 positioned within at least one of the ports.

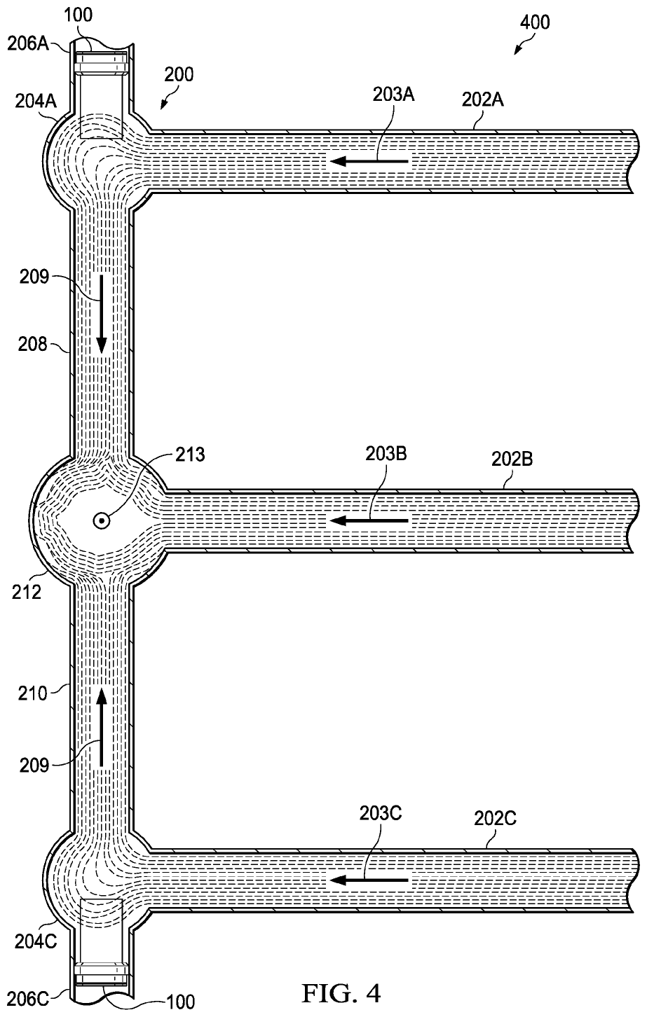

FIG. 4 is a diagram 400 illustrating fluid flow within the fluid tubing 200 using the blank and straightening vane 100. As illustrated, the blank and straightening vanes 100 positioned within the ports 206A and 206C reduce the spiral velocity of the flow of fluid as the fluid travels through pipe sections 208 and 210 in directions 209 and 211, respectively. Because the spiral velocity is reduced, the velocity of the fluid traveling in the directions 209 and 211 may be similar to the velocity of the fluid traveling in the directions 203A, 203B, and 203C within the inlet lines 202A, 202B, and 202C. For example, when the fluid traveling in the directions 203A, 203B, and 203C is moving at 35 fps, the fluid traveling in the directions 209 and 211 toward the center spherical cavity 213 may also travel at approximately 35 fps when the blank and straightening vanes 100 are positioned within the ports 206A and 206C.

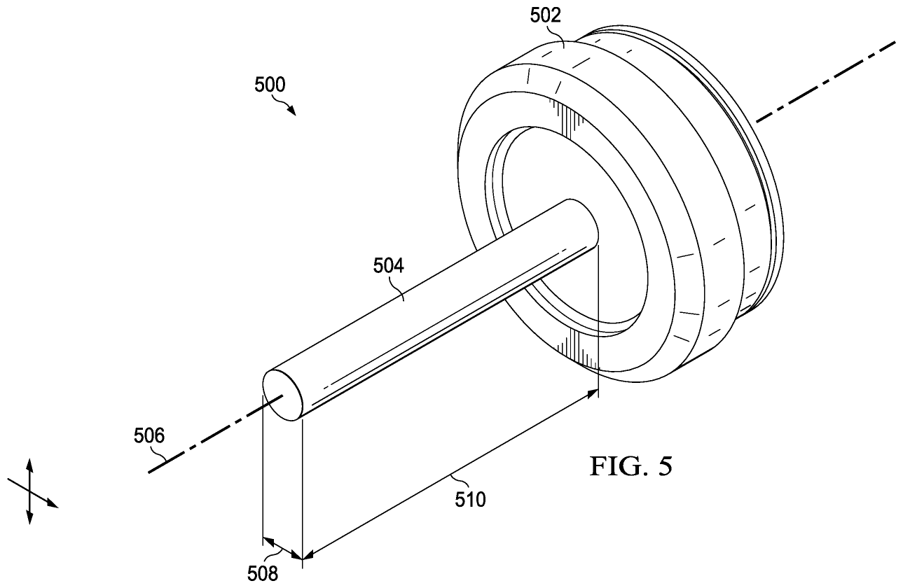

FIG. 5 is a perspective view of another embodiment of a blank and straightening vane 500. The blank and straightening vane 500 includes a blank end 502, which is similar to the blank end 102 of FIG. 1, and a straightening vane 504. The blank end 502 may be welded, machined, or mechanically coupled onto an unused port of a tee or wye pipe fitting to prevent flow of fluid in a direction of the unused port of the tee or wye pipe fitting. In another embodiment, the blank end 502 may include threads that mate with matching threads within the tee or wye pipe fitting to install the blank end 102 within the unused port of the tee or wye pipe fitting.

The straightening vane 504 protrudes from the blank end 502 along a longitudinal axis 506 of the blank and straightening vane 500. In the illustrated embodiment, the straightening vane 504 is a cylindrical shape and includes a diameter 508 of approximately ½ inch. In other embodiments, the diameter 508 may be in a range of approximately ¼ inch to 1 inch thick.

The straightening vane 504 extends from the blank end 502 along the longitudinal axis 506 a length 510 of approximately 6 inches. In other embodiments, the length 110 may be in the range of approximately 1 inch to approximately 24 inches.

As discussed in detail above with respect to FIG. 3, the blank and straightening vane 500 reduces turbulence within the fluid tubing 200 as the fluid flows through a turn of the fluid tubing 200. Further, the straightening vane 504 straightens the flow of the fluid when the fluid begins flowing in the direction of the longitudinal axis 506. That is, the straightening vane 504 prevents spiraling of the flow of fluid after the fluid traverses a turn within the fluid tubing 200.

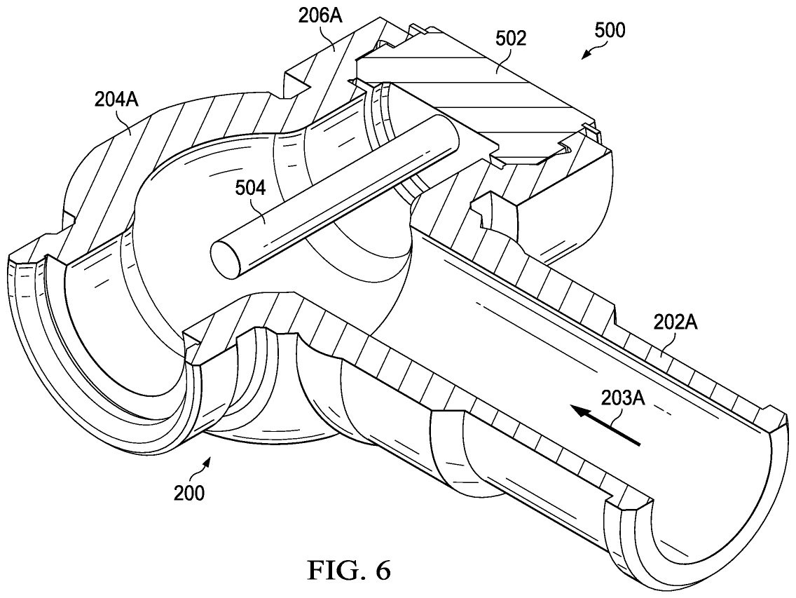

FIG. 6 is a sectional view of the blank and straightening vane 500 positioned within the fluid tubing 200. As illustrated, the blank end 502 is machined into the port 206A of the spherical cavity 204A to enable the straightening vane 504 to straighten a flow of fluid as the fluid travels from the inlet line 202A toward the center spherical chamber 212, as depicted in FIG. 3. The blank end 502 may also be welded to the port 206A or threaded into the port 206A.

The straightening vane 504 may generally be aligned in any orientation in relation to the direction 203A of travel of the fluid within the inlet line 202A due to the cylindrical shape of the straightening vane 504. Accordingly, the blank and straightening vane 500 may provide easier installation than other blank and straightening vane embodiments described herein, as the blank and straightening vane 500 is installed without consideration of a direction that one or more faces of the straightening vane 500 are facing. The straightening vane 504 reduces turbulence within the fluid tubing 200 and directs the fluid toward the center spherical chamber 212 with limited spherical velocity in relation to an embodiment with a blank end 502 without the straightening vane 504.

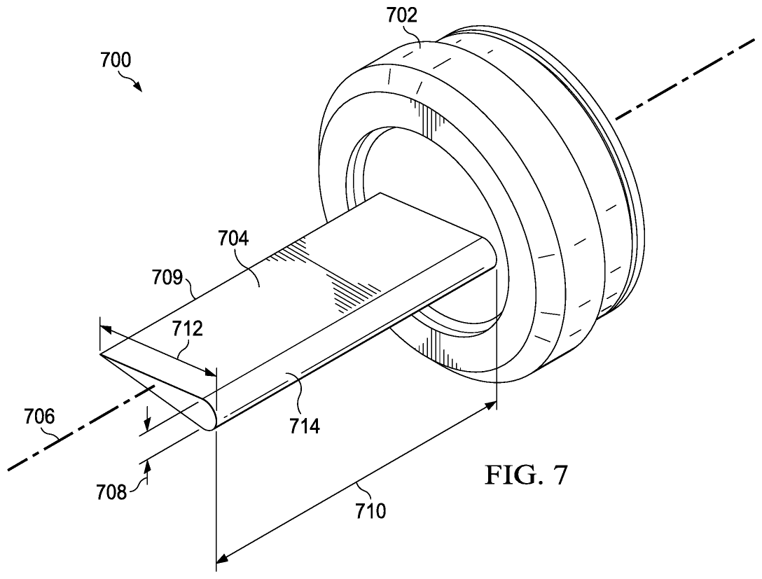

FIG. 7 is a perspective view of an additional embodiment of a blank and straightening vane 700. The blank and straightening vane 700 includes a blank end 702, which is similar to the blank ends 102 and 502, and a straightening vane 704. The blank end 702 may be welded or machined onto an unused port of a tee or wye pipe fitting to prevent flow of fluid in a direction toward the unused port of the tee or wye pipe fitting. In another embodiment, the blank end 702 may include threads that mate with matching threads within the tee or wye pipe fitting to install the blank end 702 within the unused port of the tee or wye pipe fitting.

The straightening vane 704 protrudes from the blank end 702 along a longitudinal axis 706 of the blank and straightening vane 700. In the illustrated embodiment, the straightening vane 704 includes a thickness 708 of approximately ½ inch. The thickness 708 tapers down to an edge 709 with a negligible thickness. In other embodiments, the thickness 708 may be in a range of approximately ¼ inch to 1 inch thick that tapers down to the edge 709 with a negligible thickness. As used herein, the term “approximately” indicates that a value falls within ten percent of the described amount. For example, an approximately 1 inch thick straightening vane 704 indicates that the thickness 708 of the straightening vane 704 is in the range of 0.9 inches to 1.1 inch. While the straightening vane 704 is depicted as a specific airfoil shape, in other embodiments, the straightening vane 704 may include any airfoil shape that is operable to reduce turbulence and spiraling flow of the fluid within the fluid tubing 200 as the fluid traverses a turn within the fluid tubing 200.

The straightening vane 704 extends from the blank end 702 along the longitudinal axis 706 a length 710 of approximately 6 inches. In other embodiments, the length 710 may be in the range of approximately 1 inch to approximately 24 inches. Further, a width 712 of the straightening vane 704 is approximately 2.5 inches. In other embodiments, the width 712 may be in the range of approximately ⅛ of an inch to an entire width of the blank end 702. By way of example, the blank end 702, which is sized to fit within the fluid tubing 200, may be approximately three inches across to fit within a standard section of three inch diameter frac iron. In such an embodiment, the width 712 of the straightening vane 704 may be approximately three inches.

In an embodiment, a face 714 of the straightening vane 704 is semicircular in shape. For example, the face 714 includes a semicircular geometry with a diameter equal to the thickness 708 of the straightening vane 704. In other embodiments, the face 714 may be flat, or the face 714 may include arcs of a circle that are less than an entire semicircle. That is, the face 714 may include a slighter curvature than the semicircle curvature illustrated in FIG. 7 or no curvature at all.

As discussed in detail above with respect to FIG. 3, the blank and straightening vane 700 reduces turbulence within the fluid tubing 200 as the fluid flows through a turn of the fluid tubing 200. Further, the straightening vane 704 straightens the flow of the fluid when the fluid begins flowing in the direction of the longitudinal axis 706. That is, the straightening vane 704 prevents spiraling of the flow of fluid after the fluid traverses a turn within the fluid tubing 200.

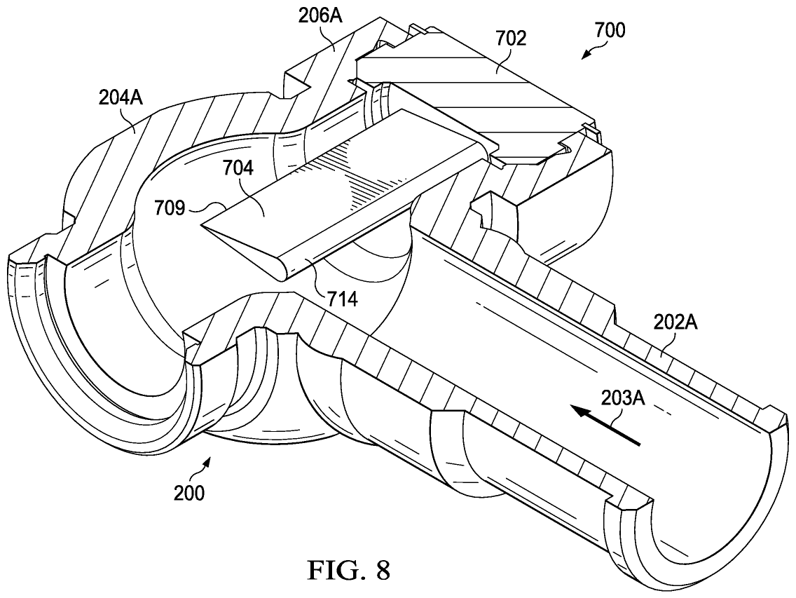

FIG. 8 is a sectional view of the blank and straightening vane 700 positioned within the fluid tubing 200. As illustrated, the blank end 702 is machined into the port 206A of the spherical cavity 204A to enable the straightening vane 704 to straighten a flow of fluid as the fluid travels from the inlet line 202A toward the center spherical chamber 212, as depicted in FIG. 3. The blank end 702 may also be welded to the port 206A, or the blank end 206A may be threaded into the port 206A.

The straightening vane 704 is aligned with the face 714 positioned to initially encounter the fluid flowing in the direction 203A when the fluid reaches the spherical cavity 204A. In other embodiments, the blank and straightening vane 700 may be rotated 180 degrees within the blank end 206A such that the edge 709 is positioned to initially encounter the fluid flowing in the direction 203A when the fluid reaches the spherical cavity 204A. The straightening vane 704 reduces turbulence within the fluid tubing 200 and directs the fluid toward the center spherical chamber 212 with limited spherical velocity in relation to an embodiment with a blank end 702 without the straightening vane 704.

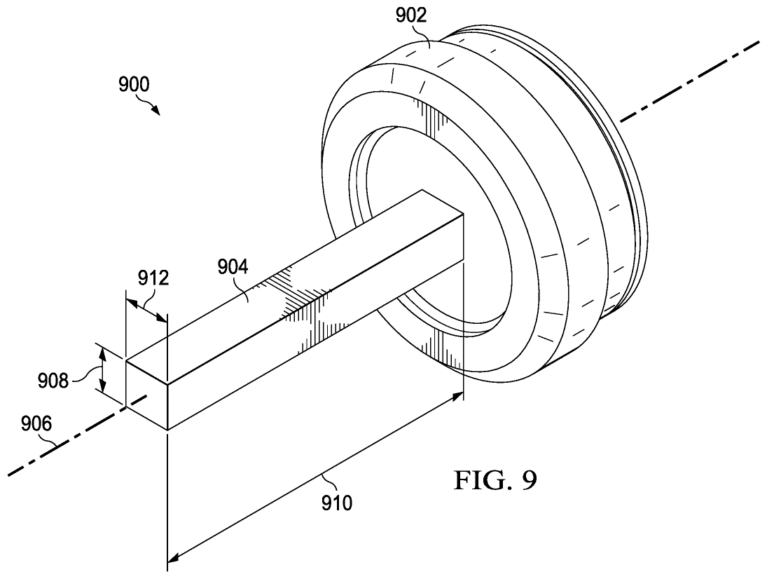

Referring to FIG. 9, a perspective view of an additional embodiment of a blank and straightening vane 900 is provided. The blank and straightening vane 900 includes a blank end 902, which is similar to the blank ends 102, 502, and 702, and a straightening vane 904. The blank end 902 may be welded or machined onto an unused port of a tee or wye pipe fitting to prevent flow of fluid in a direction of the unused port of the tee or wye pipe fitting. In another embodiment, the blank end 902 may include threads that mate with matching threads within the tee or wye pipe fitting to install the blank end 902 within the unused port of the tee or wye pipe fitting.

The straightening vane 904 protrudes from the blank end 902 along a longitudinal axis 906 of the blank and straightening vane 900. In the illustrated embodiment, the straightening vane 904 includes a thickness 908 of approximately ½ inch. In other embodiments, the thickness 908 may be in a range of approximately ¼ inch to 1 inch thick. As used herein, the term “approximately” indicates that a value falls within ten percent of the described amount. For example, an approximately 1 inch thick straightening vane 904 indicates that the thickness 908 of the straightening vane 904 is in the range of 0.9 inches to 1.1 inch.

The straightening vane 904 extends from the blank end 902 along the longitudinal axis 906 a length 910 of approximately 6 inches. In other embodiments, the length 910 may be in the range of approximately 1 inch to approximately 24 inches. A width 912 of the straightening vane 904, as illustrated, is equal to the thickness 908 of the straightening vane 904. With the width 912 and the thickness 908 of the straightening vane 904 equal, the straightening vane 904 forms a cuboid shape.

As discussed in detail above with respect to FIG. 3, the blank and straightening vane 900 reduces turbulence within the fluid tubing 200 as the fluid flows through a turn of the fluid tubing 200. Further, the straightening vane 904 straightens the flow of the fluid when the fluid begins flowing in the direction of the longitudinal axis 906. That is, the straightening vane 904 prevents spiraling of the flow of fluid after the fluid traverses a turn within the fluid tubing.

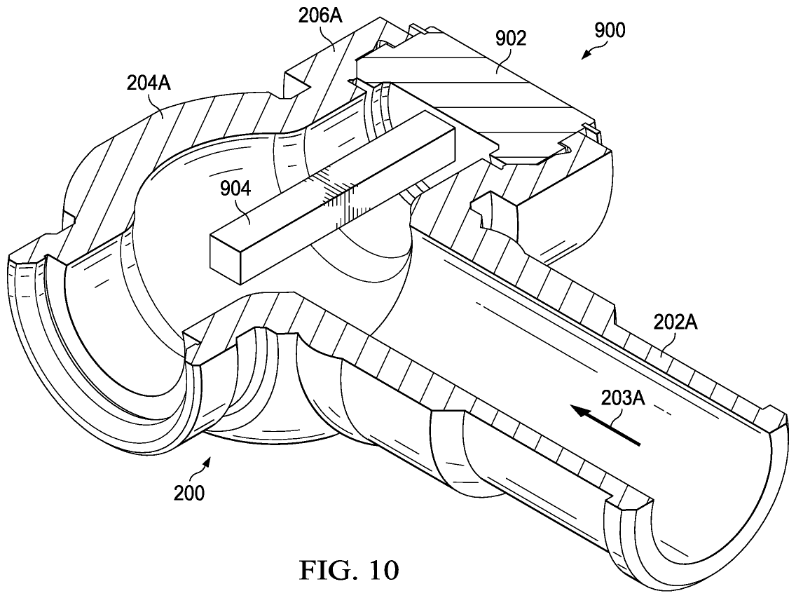

FIG. 10 is a sectional view of the blank and straightening vane 900 positioned within the fluid tubing 200. As illustrated, the blank end 902 is machined into the port 206A of the spherical cavity 204A to enable the straightening vane 904 to straighten a flow of fluid as the fluid travels from the inlet line 202A toward the center spherical chamber 212, as depicted in FIG. 3. The blank end 902 may also be welded to the port 206A, or the blank end 206A may be threaded into the port 206A.

The straightening vane 904 may be generally be aligned in any orientation in relation to the direction 203A of travel of the fluid within the inlet line 202A. The straightening vane 904 reduces turbulence within the fluid tubing 200 and directs the fluid toward the center spherical chamber 212 with limited spherical velocity in relation to an embodiment with a blank end 902 without the straightening vane 704.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, a flow straightening device, comprising: a blank end configured to reside within a portion of piping to contain fluid flow within the piping; and a straightening vane extending perpendicularly from the blank end along a longitudinal axis of the blank end, the straightening vane configured to straighten the fluid flow as the fluid flow traverses a turn within the piping.

Clause 2, the device of clause 1, wherein the straightening vane comprises a rectangular prism shape.

Clause 3, the device of clause 2, wherein a width of each rectangular face of the straightening vane is at least 0.25 inches.

Clause 4, the device of at least one of clauses 1-3, wherein the longitudinal axis of the blank end is oriented in parallel with a direction of travel of the fluid flow after the fluid flow traverses the turn within the piping.

Clause 5, the device of at least one of clauses 1-4, wherein the straightening vane consists of steel, alloy steel, corrosion resistant alloys, or a combination thereof.

Clause 6, the device of at least one of clauses 1-5, wherein the straightening vane extends from the blank end a length of between 1 inch and 24 inches.

Clause 7, the device of at least one of clauses 1-6, wherein the blank end is configured to be welded, machined, or mechanically coupled to the piping.

Clause 8, the device of at least one of clauses 1-7, wherein the blank end forms a seal within the piping to prevent the fluid flow from travelling beyond the blank end in a first direction that is opposite a direction of travel of the fluid flow after the fluid flow traverses the turn within the piping.

Clause 9, the device of at least one of clauses 1 and 4-8, wherein the straightening vane comprises a cylindrical shape, an airfoil shape, or a cuboid shape.

Clause 10, the device of clause 9, wherein a diameter or a thickness of the straightening vane is at least 0.5 inches.

Clause 11, a piping system, comprising: a section of pipe comprising at least three ports; a flow straightening device positioned within a first port of the at least three ports, the flow straightening device comprising: a blank end configured to seal the first port of the at least three ports in which the flow straightening device is positioned; and a straightening vane extending perpendicularly from the blank end along a longitudinal axis of the blank end, the straightening vane configured to straighten a flow of a fluid as the flow of fluid travels from a second port to a third port of the at least three ports.

Clause 12, the system of clause 11, wherein the straightening vane extends from the blank end in a direction toward the third port of the at least three ports.

Clause 13, the system of clause 11 or 12, wherein the section of pipe comprises a cross fitting configuration.

Clause 14, the system of at least one of clauses 11-13, wherein the section of pipe comprises a tee configuration.

Clause 15, the system of at least one of clauses 11-14, wherein the section of pipe comprises a wye configuration, and wherein an angle between the second port and the third port is greater than or equal to 30 degrees and less than 90 degrees.

Clause 16, a fluid flow assembly, comprising: an inlet configured to receive fluid flow; an outlet configured to transmit the fluid flow from the inlet toward an oil and gas well; and a port comprising a flow straightening device to direct the fluid flow from the inlet to the outlet, wherein the flow straightening device comprises: a blank end configured to seal the port in which the flow straightening device is positioned; and a straightening vane extending perpendicularly from the blank end along a longitudinal axis of the blank end, the straightening vane configured to straighten the fluid flow as the fluid flow travels from the inlet to the outlet of the piping system.

Clause 17, the assembly of clause 16, wherein the inlet, the outlet, and the port comprise a tee configuration of the fluid flow assembly.

Clause 18, the assembly of clause 16 or 17, wherein the inlet, the outlet, and the port comprise a wye configuration of the fluid flow assembly in which a turn from the inlet to the outlet is greater than 30 degrees and less than 90 degrees.

Clause 19, the assembly of at least one of clauses 16-18, wherein the fluid flow assembly comprises a frac iron system.

Clause 20, the assembly of at least one of clauses 16-19, wherein the straightening vane comprises a rectangular prism shape, a cylindrical shape, an airfoil shape, or a cuboid shape.

While this specification provides specific details related to certain components related to blank and straightening vanes, it may be appreciated that the list of components is illustrative only and is not intended to be exhaustive or limited to the forms disclosed. Other components related to the operation of the blank and straightening vanes will be apparent to those of ordinary skill in the art without departing from the scope and spirit of the disclosure. Further, the scope of the claims is intended to broadly cover the disclosed components and any such components that are apparent to those of ordinary skill in the art.

It should be apparent from the foregoing disclosure of illustrative embodiments that significant advantages have been provided. The illustrative embodiments are not limited solely to the descriptions and illustrations included herein and are instead capable of various changes and modifications without departing from the spirit of the disclosure.

What is claimed is:

1. A flow straightening device, comprising:
a blank end configured to reside within a portion of piping to contain fluid flow within the piping; and
a straightening vane extending perpendicularly from the blank end along a longitudinal axis of the blank end, the straightening vane configured to straighten the fluid flow as the fluid flow traverses a turn within the piping.

2. The device of claim 1, wherein the straightening vane comprises a rectangular prism shape.

3. The device of claim 2, wherein a width of each rectangular face of the straightening vane is at least 0.5 inches.

4. The device of claim 1, wherein the longitudinal axis of the blank end is oriented in parallel with a direction of travel of the fluid flow after the fluid flow traverses the turn within the piping.

5. The device of claim 1, wherein the straightening vane consists of steel, alloy steel, or both.

6. The device of claim 1, wherein the straightening vane extends from the blank end a length of between 1 inch and 24 inches.

7. The device of claim 1, wherein the blank end is configured to be welded, machined, or mechanically coupled to the piping.

8. The device of claim 1, wherein the blank end forms a seal within the piping to prevent the fluid flow from travelling beyond the blank end in a first direction that is opposite a direction of travel of the fluid flow after the fluid flow traverses the turn within the piping.

9. The device of claim 1, wherein the straightening vane comprises a cylindrical shape, an airfoil shape, or a cuboid shape.

10. The device of claim 9, wherein a diameter or a thickness of the straightening vane is at least 0.25 inches.

11. A piping system, comprising:
a section of pipe comprising at least three ports;
a flow straightening device positioned within a first port of the at least three ports, the flow straightening device comprising:
a blank end configured to seal the first port of the at least three ports in which the flow straightening device is positioned; and
a straightening vane extending perpendicularly from the blank end along a longitudinal axis of the blank end, the straightening vane configured to straighten a flow of a fluid as the flow of fluid travels from a second port to a third port of the at least three ports.

12. The piping system of claim 11, wherein the straightening vane extends from the blank end in a direction toward the third port of the at least three ports.

13. The piping system of claim 11, wherein the section of pipe comprises a cross fitting configuration.

14. The piping system of claim 11, wherein the section of pipe comprises a tee configuration.

15. The piping system of claim 11, wherein the section of pipe comprises a wye configuration, and wherein an angle between the second port and the third port is greater than or equal to 30 degrees and less than 90 degrees.

16. A fluid flow assembly, comprising:
an inlet configured to receive fluid flow;
an outlet configured to transmit the fluid flow from the inlet toward an oil and gas well; and
a port comprising a flow straightening device to direct the fluid flow from the inlet to the outlet, wherein the flow straightening device comprises:
a blank end configured to seal the port in which the flow straightening device is positioned; and
a straightening vane extending perpendicularly from the blank end along a longitudinal axis of the blank end, the straightening vane configured to straighten the fluid flow as the fluid flow travels from the inlet to the outlet of the piping system.

17. The assembly of claim 16, wherein the inlet, the outlet, and the port comprise a tee configuration of the fluid flow assembly.

18. The assembly of claim 16, wherein the inlet, the outlet, and the port comprise a wye configuration of the fluid flow assembly in which a turn from the inlet to the outlet is greater than 30 degrees and less than 90 degrees.

19. The assembly of claim 16, wherein the fluid flow assembly comprises a frac iron system.

20. The assembly of claim 16, wherein the straightening vane comprises a rectangular prism shape, a cylindrical shape, an airfoil shape, or a cuboid shape.
